(19) United States
(12) Patent Application Publication
(10) Pub. No.: US 2019/0114613 A1
(43) Pub. Date: Apr. 18, 2019

(54) MOBILE PHONE APP LOANS SYSTEM

(71) Applicant: SHENZHEN ZHONG XING CREDEX FINANCE TECHNOLOGY CO., LTD., Shenzhen, Guangdong (CN)

(72) Inventors: Dingwei Chen, Shenzhen, Guangdong (CN); Xia Tang, Shenzhen, Guangdong (CN); Chen Wu, Shenzhen, Guangdong (CN); Xuhui Zeng, Shenzhen, Guangdong (CN); Hao Wang, Shenzhen, Guangdong (CN); Weijie Yang, Shenzhen, Guangdong (CN); Jiangbo Zhang, Shenzhen, Guangdong (CN); Fande Bu, Shenzhen, Guangdong (CN); Haibin Wang, Shenzhen, Guangdong (CN); Kaile Tang, Shenzhen, Guangdong (CN); Xiaoqin Li, Shenzhen, Guangdong (CN); Lisha Mao, Shenzhen, Guangdong (CN); Shangliang Ding, Shenzhen, Guangdong (CN); Jingfeng Zhou, Shenzhen, Guangdong (CN); Wanka Yan, Shenzhen, Guangdong (CN)

(21) Appl. No.: 16/093,980

(22) PCT Filed: Sep. 12, 2017
(86) PCT No.: PCT/CN2017/101389

§ 371 Date: Oct. 16, 2018

(30) Foreign Application Priority Data
Sep. 13, 2016 (CN) 201610821786.2

(51) Int. Cl. G06Q 20/32; G06Q 40/02; G06Q 20/40; H04W 4/20; H04W 4/14

(52) U.S. Cl. CPC G06Q 20/3223; G06Q 40/025; H04W 4/14; G06Q 20/40145; H04W 4/20; G06Q 20/3255

(57) ABSTRACT

A mobile phone APP loans system is arranged on a network device constituted by a mobile phone, a server, a third-party service server and a bank server linked via a mobile communication network and the Internet. The mobile phone APP loans system includes a Fintech mobile phone system APP, load balancing module, mobile phone business module, short message service module, face scanning module, uniform interface module, miraculous foresight module, accounting module, clearing service module, bank interface module, third-party service module, and bank terminal module. A client fills out loan application information, and carries out cash withdrawal and repayment operations via the Fintech mobile phone system APP. Compared with the prior art, a client may borrow money on a mobile phone via a mobile phone-based loan server, which is convenient in operation, and there is no need to queue up in a banking office, and the loan speed is fast.

### TECHNICAL FIELD OF THE INVENTION

The present invention relates to the field of Internet finance technologies, and more particularly, to a mobile phone APP loans system.

### BACKGROUND OF THE INVENTION

It is difficult in the traditional loan application because a borrower needs to submit a large number of paper proof materials to a lending institution and the borrower cannot process a loan unless the borrower goes to a banking office on weekdays. Furthermore, after the application is filed, the borrower needs to wait a long time for examination and approval. Even though the application is approved, a low loan speed brings a lot of inconvenience to a user because the lending institution cannot timely make loans to the user, which causes many commercial opportunities to be missed. Sometimes the lending institution also needs the user to satisfy some additional conditions before lending money to the user. For example, the user needs to deposit a certain amount of money in a bank or purchase some financing products, which brings difficulties to the user who is already under financial strain. Moreover, it is impossible to withdraw a part of money via the traditional loan application. The loan limit applied by the user must be used up at one go. That is, the user must borrow full amount of money even though the user temporarily does not need so much money. Furthermore, neither partial repayment nor prepayment in full amount is supported. A penal sum needs to be paid for prepayment. Besides, the user can neither change the due date nor adjust the repayment period, which brings difficulties to the user in repayment. After a loan is paid up, the user needs to resubmit an application for another loan, which brings difficulties for another loan.

In the prior art, applying for loan can only be handled at a banking office of a bank. Even though online banking is used, it is impossible for a borrower to borrow and repay money to a plurality of banks whenever and wherever due to large amount of data and low speed.

### SUMMARY OF THE INVENTION

A technical problem to be solved by the present invention is to facilitate a borrower to borrow money whenever and wherever.

A second technical problem to be solved by the present invention is to facilitate the borrower to pay back the borrowed money whenever and wherever.

For this purpose, according to a first aspect of the present invention, an embodiment provides a mobile phone APP loans system.

The mobile phone APP loans system is arranged on a network device constituted by a mobile phone, a server, a third-party service server, and a bank server linked by using a mobile communication network and the Internet. The mobile phone APP loans system includes a Fintech mobile phone system APP, a load balancing module, a mobile phone business module, a short message service module, a face scanning module, a uniform interface module, a miraculous foresight module, an accounting module, a clearing service module, a bank interface module, a third-party service module, and a bank terminal module. The Fintech mobile phone system APP is used to fill out a short-message verification code sent from the short message service module to a client's mobile phone when a client registers on the mobile phone system APP and fill out a loan verification code sent from the short message service module to the client's mobile phone when the client withdraws cash. The client fills out loan application information via the Fintech mobile phone system APP, then encrypts it to obtain encrypted application information, and sends the encrypted application information to a content distribution module. The Fintech mobile phone system APP receives a loan contract and a loan limit sent from the uniform interface module. In a cash withdrawal operation, the client fills out the loan contract and the loan verification code via the Fintech mobile phone system APP, sets a cash withdrawal password, and generates a cash withdrawal amount, an operable cash withdrawal amount in the cash withdrawal operation is within the loan limit, and then the loan contract, the loan verification code, the cash withdrawal amount and the cash withdrawal password are sent to the miraculous foresight module. The Fintech mobile phone system APP receives the successfully verified loan contract sent from the miraculous foresight module, such that the client validates the loan contract, and then sends the validated loan contract to the miraculous foresight module. The content distribution module receives the encrypted application information sent from the Fintech mobile phone system APP, carries out data transmission and processing via the Internet to obtain client application information, and sends it to the load balancing module. The load balancing module distributes, the client application information sent from the content distribution module, to the mobile phone business module based on an IP load balancing determination and content request distribution method. After receiving the client application information sent from the load balancing module, the mobile phone business module generates a short-message verification code, and sends it to the short message service module. The mobile phone business module carries out data de-packetization on the client application information sent from the load balancing module to obtain the de-packetized client application information: a user name, often-living-in city, limit of a single credit card, position, race, number of children, marital status, working hours recently, start working time, company name, nature of unit, position held, monthly income, mobile phone number, education level, mailbox, real estate information, current residential address, identity card information, bank card information, face information, signature information, and information on license terms consented by the user. The mobile phone business module sends the face information to the face scanning module. The mobile phone business module sends the de-packetized client application information to the uniform interface module. The mobile phone business module receives a photo comparison score sent from the face scanning module, validates and then saves the photo comparison score. The mobile phone business module receives loan result information sent from the bank terminal module, generates a loan message, and sends it to the short message service module.

The short message service module receives the short-message verification code sent from the mobile phone business module, then generates a short message notice in line with mobile communication network transmission, and sends the short message notice to the client's mobile phone by way of a short message. Meanwhile the Fintech mobile phone system APP displays that a time limit of entering the short-message verification code is one hour. When the client carries out the cash withdrawal operation via the Fintech mobile phone system APP, the client clicks on a short-message sending button on a screen, such that the short message service module sends the loan verification code to the client's mobile phone. The short message service module receives the loan message sent from the mobile phone business module, then generates a short message notice in line with mobile communication network transmission, and sends the short message notice to the mobile phone number filled out when the client registers by way of a short message. The face scanning module receives the face information sent from the mobile phone business module, compares the face information with the client's photo sent from the third-party service module, calculates based on the client's facial feature similarity between the two photos to obtain a photo comparison score, and then sends the photo comparison score to the mobile phone business module. The uniform interface module receives the de-packetized client application information sent from the mobile phone business module, and sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information to the accounting module. The bank card information and the face scanning information are sent to the miraculous foresight module. The uniform interface module receives the client's loan limit sent from the accounting module. The uniform interface module sends the loan contract downloaded from a master server and the loan limit sent back from the accounting module to the Fintech mobile phone system APP. The uniform interface module sends the loan contract, the bank card information and the loan limit to the clearing service module. The uniform interface module sends the user name, the identity card information, the signature information and the information on license terms consented by the user to the third-party service module. The uniform interface module receives a credit score of the client sent from the third-party service module. The uniform interface module sends the credit score to the miraculous foresight module. The miraculous foresight module receives the bank card information and the face scanning information sent from the uniform interface module, receives the loan contract, the cash withdrawal amount, the loan verification code and the cash withdrawal password sent from the Fintech mobile phone system APP and saves the cash withdrawal password, receives the client's photo and the client's bank information sent from the third-party service module, and then sends again the successfully verified loan contract to the Fintech mobile phone system APP after all the information is verified to be correct. The miraculous foresight module receives the validated loan contract sent back from the Fintech mobile phone system APP, makes a loan, obtains a loan notice to the client, and sends it to the clearing service module. The miraculous foresight module receives and saves the credit score sent from the uniform interface module. The accounting module receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information sent from the uniform interface module, calculates the client's loan limit, and sends it back to the uniform interface module. The clearing service module receives the loan contract, the bank card information and the loan limit sent from the uniform interface module and the loan notice to the client sent from the miraculous foresight module, verifies whether the cash withdrawal amount is within the loan limit, and carries out loan notice processing once verified to be eligible. The clearing service module generates a loan message and sends it to the bank interface module. The bank interface module receives the loan message sent from the clearing service module, processes the loan message to obtain the client's loan information, and sends it to the bank terminal module. The client's loan information includes the client's cash withdrawal amount and the client's bank card information. The bank terminal module receives the client's loan information sent from the bank interface module, transfers the cash withdrawal amount in the client's loan information into the client's bank card, and sends obtained loan result information to the mobile phone business module. The content of the loan result information includes loan succeeded or loan failed. The third-party service module sends the client's photo to the face scanning module. The third-party service module sends the client's photo and the client's bank information to the miraculous foresight module. The third-party service module receives the user name, the identity card information, the signature information and the information on license terms consented by the user sent from the uniform interface module. The third-party service module obtains the client's credit rating score based on synthesis, and sends it to the uniform interface module.

Compared with the prior art, by using the mobile phone APP loans system according to the present invention, a client may borrow money on a mobile phone via a mobile phone-based loan server, which is convenient in operation, so the client does not need to queue up in a banking office, thereby achieving a high speed of borrowing money.

Moreover, the client may repay money on the mobile phone, which is also convenient in operation, such that the client does not need to queue up in the banking office, and there is no limitation to repayment time, such that the client may borrow and repay whenever.

### BRIEF DESCRIPTION OF THE DRAWINGS

FIG. 1 is a schematic diagram of a device connection adopted by a mobile phone APP loans system according to an embodiment; and

FIG. 2 is a schematic structural diagram of the mobile phone APP loans system according to this embodiment.

### DETAILED DESCRIPTION OF EMBODIMENTS

The present invention is further described in detail in the following with reference to the accompanying drawings and embodiments. The mobile phone APP loans system (this system) according to the present invention is arranged on a network device constituted by a mobile phone, a server, a third-party service server, and a bank server linked by using a mobile communication network and the Internet. The mobile phone on which a Fintech mobile phone system APP is installed is networked with the server, and the server is networked to the third-party service server and the bank server. The third-party service server and the bank server are respectively linked with one or more computer terminals (computers). In this embodiment, the Fintech mobile phone system APP refers to an application tool installed on the mobile phone.

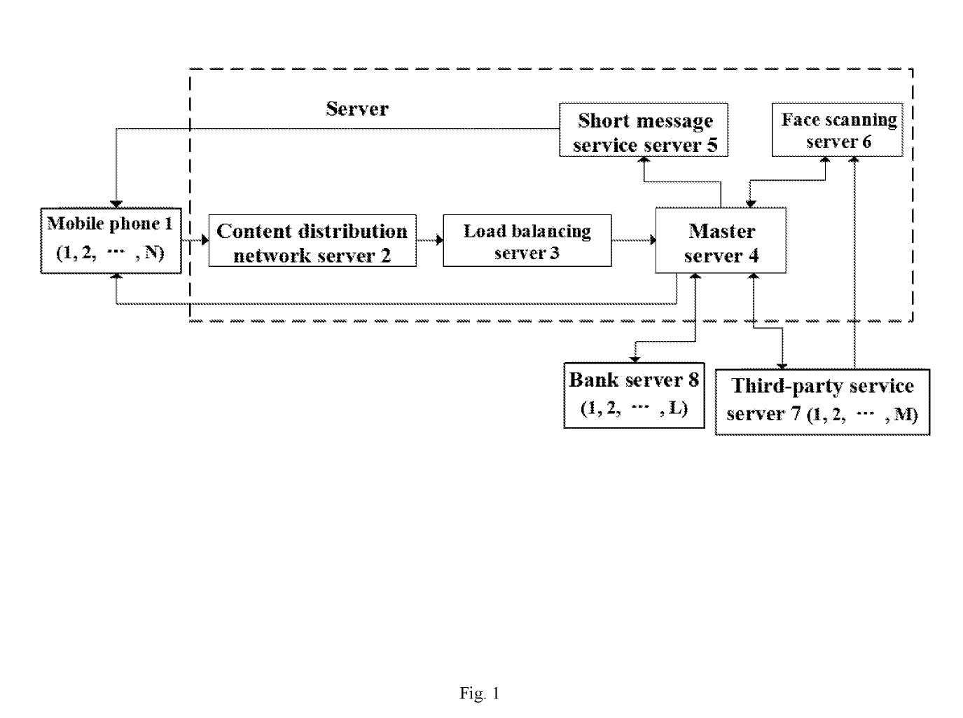

As shown in FIG. 1, the mobile phone APP loans system in the present invention adopts the following devices: the mobile phone 1, the server, the third-party service server 7, and the bank server 8. The server is constituted by a content distribution network server 2, a load balancing server 3, a master server (Fintech financial technology server) 4, a short message service server 5, and a face scanning service server 6. There is provided with N mobile phones 1, the N being the number of users registered on this system. The mobile phone 1 is connected to the master server 4 via the content distribution network server 2 and the load balancing server 3. The master server 4 is connected to the short message service server 5, the face scanning service server 6, the third-party service server 7, and the bank server 8. There is provided with M third-party service servers 7, the M being the number of servers connected to this system and providing credit, criminal records and credit inquiry information for this system. There is provided with L bank servers 8, the L being the number of bank servers connected to this system and providing a loan.

In this embodiment, the mobile phone 1 is a smart mobile phone installed with an IOS system (a mobile operating system developed by Apple Inc.) or an Android system (a free and open-source operating system based on Linux), and the mobile phone 1 shall be equipped with a front camera of more than two million pixels for photographing. The content distribution network server 2 adopts a quad-core CPU, a memory of 8,192 MB, and a hard-disk space of 40 G. The load balancing server 3 adopts a quad-core CPU, a memory of 8,192 MB, and a hard-disk space of 40 G. The master server 4 adopts a quad-core CPU, a memory of 8,192 MB, and a hard-disk space of 40 G. The short message service server 5 adopts a quad-core CPU, a memory of 8,192 MB, and a hard-disk space of 40 G. The face scanning service server 6 adopts a quad-core CPU, a memory of 8,192 MB, and a hard-disk space of 40 G. The third-party service server 7 adopts a quad-core CPU, a memory of 8,192 MB, and a hard-disk space of 40 G. The bank server 8 adopts a quad-core CPU, a memory of 8,192 MB, and a hard-disk space of 40 G. The mobile phone 1 is linked to the content distribution network server 2 and the short message service server 5 by using a mobile communication network. The content distribution network server 2 is linked to the load balancing server 3, and the master server 4 is linked to the load balancing server 3, the short message service server 5, and the face scanning service server 6, via the Internet. The master server 4 is linked to the third-party service server 7 and the bank server 8 via the Internet.

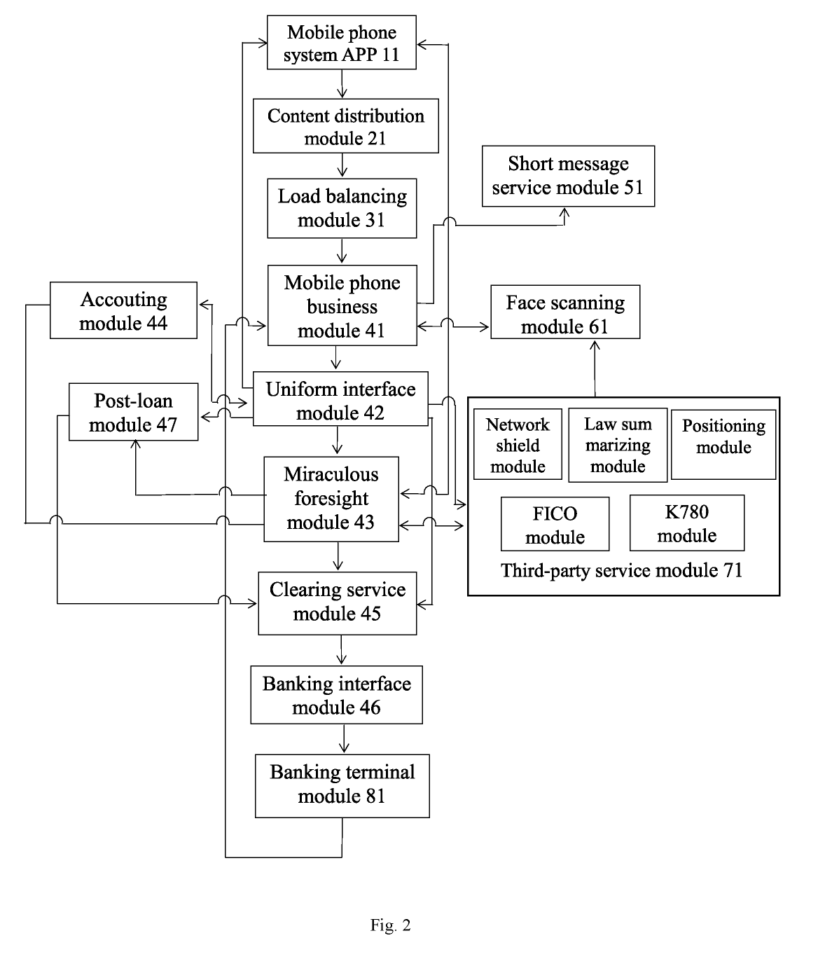

As shown in FIG. 2, the mobile phone APP loans system according to the present invention is provided with a Fintech mobile phone system APP 11, a content distribution module 21, a load balancing module 31, a short message service module 51, a face scanning module 61, a third-party service module 71, a bank terminal module 81, a mobile phone business module 41, a uniform interface module 42, a miraculous foresight module 43, an accounting module 44, a clearing service module 45, a bank interface module 46, and a post-loan module 47. The third-party service module 71 is provided with a network shield module, a law summarizing module, a positioning module, a credit rating FICO module, and a K780 module.

A client fills out loan application information via the Fintech mobile phone system APP 11, and the Fintech mobile phone system APP encrypts the information and sends the encrypted application information to the content distribution module 21.

The application information includes: a user name, often-living-in city, limit of a single credit card, position, race, number of children, marital status, working hours recently, start working time, company name, nature of unit, position held, monthly income, mobile phone number, education level, mailbox, real estate information, current residential address, identity card information, bank card information, face information, signature information, information on license terms consented by the user, and loan limit. The identity card information includes a front photo and a reverse photo of an identity card photographed by using a mobile phone, and the face information includes a front photo of a face photographed by using a mobile phone. The information on license terms consented by the user includes information on terms consented by the user to authorize a third-party service.

The client is the user registered on this system, and the client's mobile phone number and password are stored in a database of the master server 4. After the client registers to become the user of this system, the client can login to this system by filling out the correct mobile phone number and password.

When the client registers, the short message service module 51 shall send a short-message verification code to the mobile phone of the client who is registering, and the client needs to fill out the short-message verification code in the Fintech mobile phone system APP 11 to determine the authenticity of the mobile phone number filled out by the client. When the client withdraws cash, the client also needs to fill out a loan verification code sent from the short message service module 51 to determine whether the concrete operation is performed by the client personally. The client's account security can be protected by using the verification code service provided by the short message service module 51.

The Fintech mobile phone system APP 11 receives a loan contract and a loan limit sent from the uniform interface module 42. In a cash withdrawal operation, the client fills out the loan contract and the loan verification code via the Fintech mobile phone system APP 11, sets a cash withdrawal password, and carries out the cash withdrawal operation, and generates a cash withdrawal amount. An operable cash withdrawal amount in the cash withdrawal operation is within the loan limit, and then the loan contract, the loan verification code, the cash withdrawal amount and the cash withdrawal password are sent to the miraculous foresight module 43.

The Fintech mobile phone system APP 11 receives the successfully verified loan contract sent from the miraculous foresight module 43, and then sends the validated loan contract to the miraculous foresight module 43 after the client carries out a validation operation.

The content distribution module 21 receives the encrypted application information sent from the Fintech mobile phone system APP 11, carries out data transmission and processing via the Internet after obtaining the client application information, and sends it to the load balancing module 31. The content distribution module 21 is used to transmit a lot of data.

The load balancing module 31 distributes the client application information sent from the content distribution module 21 based on an IP load balancing determination and content request distribution method. That is, the load balancing module 31 determines the load of a page view and a concurrent page view for the mobile phone business module 41, and then distributes the client application information to the mobile phone business module 41.

IP load balancing is implemented by way of an IPVS (short for IP Virtual Server, running under an LVS and serving as a way of providing a load balancing function) module. As a core system of a cluster system, the IPVS plays a role as below: it is installed on a director server (a scheduler), and meanwhile an IP address is virtualized on the director server, such that a user accesses services via this virtual IP address. This virtual IP generally is referred to as a VIP (i.e., virtual IP) of an LVS (short for Linux Virtual Server, which is a virtual server cluster system). An access request first reaches a load scheduler via the VIP, and then the load scheduler selects, from a real server list, an appropriate service node to respond to the user's request. The appropriate service node is a service node that is not busy or is the nearest in geographical location.

After receiving the client application information sent from the load balancing module 31, the mobile phone business module 41 generates a short-message verification code, and sends it to the short message service module 51.

The mobile phone business module 41 carries out data de-packetization on the client application information sent from the load balancing module 31 to obtain the de-packetized client application information: a user name, often-living-in city, limit of a single credit card, position, race, number of children, marital status, working hours recently, start working time, company name, nature of unit, position held, monthly income, mobile phone number, education level, mailbox, real estate information, current residential address, identity card information, bank card information, face information, signature information, and information on license terms consented by the user.

The mobile phone business module 41 sends the face information to the face scanning module 61.

The mobile phone business module 41 sends the de-packetized rest application information of the client to the uniform interface module 42.

The mobile phone business module 41 receives a photo comparison score sent from the face scanning module 61, validates and then saves the photo comparison score for preventing anyone other than the client from applying.

The mobile phone business module 41 receives loan result information sent from the bank terminal module 81, generates a loan message, and sends it to the short message service module 51.

The short message service module 51 receives the short-message verification code sent from the mobile phone business module 41, then generates a short message notice in line with mobile communication network transmission, and sends the short message notice to the client's mobile phone by way of a short message, and meanwhile the Fintech mobile phone system APP 11 restricts that a time limit of entering the short-message verification code is one hour. For example, the content of the short-message verification code is as below: “your verification code is 906513, please enter it within one hour. To guarantee your account security, please do not forward the short-message verification code to others.”

When the client carries out the cash withdrawal operation via the Fintech mobile phone system APP 11, he clicks on a short-message sending button on the screen thereof, such that the short message service module 51 sends the loan verification code to the client's mobile phone.

The short message service module 51 receives the loan message sent from the mobile phone business module 41, then generates a short message notice in line with mobile communication network transmission, and sends, by way of a short message, the short message notice to the mobile phone number filled out when the client registers.

The face scanning module 61 receives the face information sent from the mobile phone business module 41, receives and compares the client's photo sent from the third-party service module 71 with the face information, calculates based on the client's facial feature similarity between the two photos to obtain a photo comparison score, and then sends the photo comparison score to the mobile phone business module 41.

The uniform interface module 42 receives the de-packetized client application information sent from the mobile phone business module 41, and sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information to the accounting module 44.

The uniform interface module 42 sends the bank card information and the face scanning information to the miraculous foresight module 43.

The uniform interface module 42 receives the client's loan limit sent from the accounting module 44.

The uniform interface module 42 sends the loan contract downloaded from the master server 4 and the loan limit sent back from the accounting module 44 to the Fintech mobile phone system APP 11.

The uniform interface module 42 sends the loan contract, the bank card information and the loan limit to the clearing service module 45.

The uniform interface module 42 sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information in the application information to the post-loan module 47.

The uniform interface module 42 sends the user name, the identity card information, the signature information and the information on license terms consented by the user to the third-party service module 71.

The uniform interface module 42 receives a credit rating score of the client sent from the third-party service module 71.

The uniform interface module 42 sends the credit score to the miraculous foresight module 43.

The miraculous foresight module 43 receives the bank card information and the face scanning information sent from the uniform interface module 42, receives the loan contract, the cash withdrawal amount, the loan verification code and the cash withdrawal password sent from the Fintech mobile phone system APP 11 and saves the cash withdrawal password, and receives the client's photo and the client's bank information sent from the third-party service module 71. Next, (a) the miraculous foresight module 43 checks whether the client's cash withdrawal amount is within the loan limit; (b) the miraculous foresight module 43 compares the face scanning information with the client's photo provided by the third-party service module 71 to check whether the operation is carried out by the client personally, and compares the bank card information with the client's bank information provided by the third-party service module 71 to check whether the bank card belongs to the client; and (c) the miraculous foresight module 43 verifies whether the entered cash withdrawal password and the loan verification code are correct. After all the information is verified to be correct, the miraculous foresight module 43 sends again the successfully verified loan contract to the Fintech mobile phone system APP 11 for requesting the client to validate it.

The miraculous foresight module 43 receives the validated loan contract sent back from the Fintech mobile phone system APP 11, makes a loan, obtains a loan notice to the client, and sends it to the clearing service module 45.

The miraculous foresight module 43 receives the client's information of overdue payment sent from the accounting module 44. The client's information of overdue payment includes overdue amount and overdue days. Next, the miraculous foresight module 43 sends the client's information of overdue payment to the post-loan service module 47.

The miraculous foresight module 43 receives and saves the credit score sent from the uniform interface module 42.

The accounting module 44 receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information sent from the uniform interface module 42, obtains the client's loan limit and repayment date by calculation, and sends the loan limit back to the uniform interface module 42.

The accounting module 44 obtains the client's information of overdue payment by calculation based on the repayment date, and sends it to the miraculous foresight module 43. If the client still does not repay on the repayment date, the client status is changed to be overdue.

The clearing service module 45 receives the loan contract, the bank card information and the loan limit sent from the uniform interface module 42 and the loan notice to the client sent from the miraculous foresight module 43, verifies whether the cash withdrawal amount is within the loan limit, checks whether the operation (face scanning information) is carried out by the client personally, checks whether the bank card belongs to the client himself, verifies whether the cash withdrawal password and the short-message verification code are correctly entered, signs the loan contract, and carries out loan notice processing once verified and checked to be eligible. The clearing service module 45 generates a loan message and sends it to the bank interface module 46.

The clearing service module 45 receives the offer amount sent from the post-loan module 47, generates an offer file, and sends it to the bank interface module 46. The offer amount refers to the client's need-to-pay amount. The offer file includes the bank card information and the offer amount. The offer file is sent to a bank system for money deduction, and the money deducted is the client's need-to-pay amount at maturity.

The bank interface module 46 receives the loan message sent from the clearing service module 45, processes the loan message to obtain the client's loan information, and sends the client's loan information to the bank terminal module 81. The client's loan information includes the client's cash withdrawal amount and the client's bank card information.

The bank interface module 46 receives the offer file sent from the clearing service module 45, carries out money deduction, obtains a counteroffer file indicating whether the money deduction is successful, and then sends it to the bank terminal module 81.

The post-loan module 47 receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information sent from the uniform interface module 42 and makes an offer, or receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information sent from the uniform interface module 42 and the overdue amount and the overdue days sent from the miraculous foresight module 43, then makes an offer to obtain an offer amount, and sends the offer amount to the clearing service module 45. The offer amount refers to the client's need-to-pay amount.

The offer processing is as below: the client's offer amount is obtained artificially by calculation via a PC, or by contacting the client after the client application information is viewed, to communicate with the client about repayment matters.

The bank terminal module 81 receives the client's loan information sent from the bank interface module 46, transfers the cash withdrawal amount in the client's loan information into the client's bank card, and sends obtained loan result information to the mobile phone business module 41. The content of the loan result information includes loan succeeded or loan failed. Applying for a loan is completed for the client.

The bank terminal module 81 receives the counteroffer file sent from the bank interface module 46, and verifies whether the money deduction is successful. A successful money deduction indicates the completion of repayment. In case of failed money deduction, the bank interface module 46 shall continuously initiate money deduction within one day. In case of failed money deduction on that day, the client's overdue time is recalculated.

There is provided with L bank terminal modules 81. L is the number of the bank servers connected to this system and providing a loan.

The third-party service module 71 sends the client's photo to the face scanning module 61.

The third-party service module 71 sends the client's photo and the client's bank information to the miraculous foresight module 43.

The third-party service module 71 receives the user name, the identity card information, the signature information and the information on license terms consented by the user sent from the uniform interface module 42.

The third-party service module 71 is provided with a network shield module, a law summarizing module, a positioning module, an individual credit rating FICO module, and a K780 module working collaboratively. The third-party service module 71 obtains the client's credit rating score based on synthesis, and sends it to the uniform interface module 42 to assess whether the client's credit is good.

The network shield module is used to learn whether the client is a deceiver, for example, whether the client is involved in an abnormal loan, a risk of losing credit, or a loan strategy. The loan strategy may include, for example, the client's fraudulent data, being blacklisted by what kind of financing institutions, and a geographical location where the client is.

The law summarizing module is used to learn whether the client is involved in a financial case under progress in a court.

The positioning module is used to position the mobile phone, determine the client's sphere of activity, and estimate whether the client has a risk of losing credit.

The individual credit rating FICO module is used to integrate the results learned by the network shield module and the law summarizing module, give a credit score and send it to the uniform interface module 42, which sends the credit score to the miraculous foresight module 43 for saving.

The K780 module is used to collect a mobile phone number, an identification IP address, an identity card number and a short URL provided by the client, then provide an inquiry service, and provide a short URL shortening service and a two-dimensional code generating service.

Working processes of the system according to the present invention are as follows:

Borrowing

The client fills out loan application information via the Fintech mobile phone system APP 11, and the loan application information is encrypted and then the encrypted application information is sent to the content distribution module 21.

The content distribution module 21 receives the encrypted application information sent from the Fintech mobile phone system APP 11, carries out data transmission and processing via the Internet. The content distribution module 21 can transmit and process a large amount of data. After obtaining client application information, it is sent to the load balancing module 31.

The load balancing module 31 distributes the client application information sent from the content distribution module 21 based on an IP load balancing determination and content request distribution method. Then, the client application information is distributed to the mobile phone business module 41.

After receiving the client application information sent from the load balancing module 31, the mobile phone business module 41 generates a short-message verification code, and sends it to the short message service module 51.

The short message service module 51 receives the short-message verification code sent from the mobile phone business module 41, then generates a short message notice in line with mobile communication network transmission, and sends the short message notice, by way of a short message, to the mobile phone number filled out when the client registers, and meanwhile the Fintech mobile phone system APP 11 restricts that a time limit of entering the verification code is one hour. For example, the content of the short message notice is as below: “your verification code is 906513, please enter it within one hour. To guarantee your account security, please do not forward the verification code to others.”

The mobile phone business module 41 carries out data de-packetization on the client application information sent from the load balancing module 31 to obtain the de-packetized client application information: a user name, often-living-in city, limit of a single credit card, position, race, number of children, marital status, working hours recently, start working time, company name, nature of unit, position held, monthly income, mobile phone number, education level, mailbox, real estate information, current residential address, identity card information, bank card information, face information, signature information, and information on license terms consented by the user.

The mobile phone business module 41 sends the face information to the face scanning module 61.

The mobile phone business module 41 sends the de-packetized client application information to the uniform interface module 42.

The face scanning module 61 compares the face information sent from the mobile phone business module 41 with the client's photo obtained from the third-party service module 71, calculates based on the client's facial feature similarity between the two photos to obtain a photo comparison score, and then sends the photo comparison score back to the mobile phone business module 41. The mobile phone business module 41 validates and then saves the photo comparison score to prevent from an illegal application. After validating, the mobile phone business module 41 sends the client application information to the uniform interface module 42.

The uniform interface module 42 receives the de-packetized client application information sent from the mobile phone business module 41, and sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information to the accounting module 44. The accounting module 44 obtains the client's loan limit by calculation, and sends it back to the uniform interface module 42. The uniform interface module 42 sends the bank card information and the face scanning information in the client application information to the miraculous foresight module 43.

The uniform interface module 42 sends the loan contract downloaded from the master server 4 and the loan limit sent back from the accounting module 44 to the Fintech mobile phone system APP 11. Meanwhile, the client clicks on a short-message sending button on the screen via the Fintech mobile phone system APP 11, such that the short message service module 51 sends the loan verification code to the mobile phone corresponding to the mobile phone number filled out by client. The Fintech mobile phone system APP 11 receives the loan contract and the loan limit sent from the uniform interface module 42. In a cash withdrawal operation, the client fills out the loan contract and the loan verification code via the Fintech mobile phone system APP 11, sets a cash withdrawal password, carries out the cash withdrawal operation, and generates a cash withdrawal amount. An operable cash withdrawal amount in the cash withdrawal operation is within the loan limit, and then the loan contract, the loan verification code, the cash withdrawal amount and the cash withdrawal password are sent to the miraculous foresight module 43.

The miraculous foresight module 43 receives the bank card information and the face scanning information in the client application information sent from the uniform interface module 42, receives the loan contract, the cash withdrawal amount, the loan verification code and the cash withdrawal password sent from the Fintech mobile phone system APP 11 and saves the cash withdrawal password, and receives the client's photo and the client's bank information sent from the third-party service module 71. Next, (a) the miraculous foresight module 43 checks whether the client's cash withdrawal amount is within the loan limit; (b) the miraculous foresight module 43 compares the face scanning information with the client's photo provided by the third-party service module 71 to check whether the operation is carried out by the client personally, and compares the bank card information with the client's bank information provided by the third-party service module 71 to check whether the bank card belongs to the client himself; (c) the miraculous foresight module 43 verifies whether the entered cash withdrawal password and the loan verification code are correct. The successfully verified loan contract is sent again to the Fintech mobile phone system APP 11 after all the information is verified to be correct, for requesting the client to validate. The loan contract validated by the client via the Fintech mobile phone system APP 11 is sent to the miraculous foresight module 43. The miraculous foresight module 43 receives the validated loan contract sent back from the Fintech mobile phone system APP 11, makes a loan, obtains a loan notice to the client, and sends it to the clearing service module 45.

The clearing service module 45 receives the loan contract, the bank card information and the loan limit sent from the uniform interface module 42 and the loan notice to the client sent from the miraculous foresight module 43, verifies whether the cash withdrawal amount is within the loan limit, checks whether the operation (face scanning information) is carried out by the client personally, checks whether the bank card belongs to the client himself, verifies whether the cash withdrawal password and the short-message verification code are correctly entered, signs the loan contract, and carries out loan notice processing once verified and checked to be eligible. The clearing service module 45 generates a loan message and sends it to the bank interface module 46.

The bank interface module 46 receives the loan message sent from the clearing service module 45, processes the loan message to obtain the client's loan information, and sends it to the bank terminal module 81. The client's loan information includes the client's cash withdrawal amount and the client's bank card information.

The bank terminal module 81 transfers the cash withdrawal amount in the client's loan information into the client's bank card, and sends obtained loan result information to the mobile phone business module 41. The content of the loan result information includes loan succeeded or loan failed. The mobile phone business module 41 generates a loan message, and sends it to the short message service module 51. The short message service module 51 generates a short message notice in line with mobile communication network transmission, and sends the short message notice to the mobile phone number filled out when the client registers by way of a short message. Applying for a loan is completed for the client.

Repayment

The client repays via the Fintech mobile phone system APP 11, or repayment is automatically initiated at maturity. The uniform interface module 42 sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information in the application information to the post-loan module 47.

The post-loan module 47 receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information in the application information sent from the uniform interface module 42, makes an offer to obtain an offer amount, and sends the offer amount to the clearing service module 45. The offer amount is the client's need-to-pay amount. The offer processing is as below: the client's offer amount is obtained artificially by calculation via a PC, or by contacting the client after the client's application information is viewed, to communicate with the client about repayment matters.

The clearing service module 45 receives the offer amount sent from the post-loan module 47, generates an offer file, and sends it to the bank interface module 46. The offer amount refers to the client's need-to-pay amount. The offer file includes the bank card information and the offer amount. The offer file is sent to a bank system for money deduction, and the money deducted is the client's need-to-pay amount at maturity.

The bank interface module 46 receives the offer file sent from the clearing service module 45, carries out money deduction, obtains a counteroffer file indicating whether the money deduction is successful, and then sends it to the bank terminal module 81.

The bank terminal module 81 receives the counteroffer file sent from the bank interface module 46, and verifies whether the money deduction is successful. A successful money deduction indicates completion of repayment. In case of failed money deduction, the bank interface module 46 shall continuously initiate money deduction within one day.

Client Overdue Payment

When the accounting module 44 determines that the client is overdue, the uniform interface module 42 sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, and the bank card information in the application information to the post-loan module 47.

The accounting module 44 receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information sent from the uniform interface module 42, obtains a repayment date for the client by calculation, obtains the client's information of overdue payment by calculation based on the repayment date, and sends it to the miraculous foresight module 43. The miraculous foresight module 43 receives the client's information of overdue payment sent from the accounting module 44, obtains the overdue amount and overdue days in the client's information of overdue payment, and sends them to the post-loan service module 47.

After the post-loan module 47 receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information in the client application information sent from the uniform interface module 42 and receives information on the overdue amount and the overdue days sent from the miraculous foresight module 43, the post-loan module 47 makes an offer to obtain an offer amount, and sends it to the clearing service module 45.

The clearing service module 45 receives the offer amount sent from the post-loan module 47, generates an offer file, and sends it to the bank interface module 46.

The bank interface module 46 receives the offer file sent from the clearing service module 45, carries out a money deduction, obtains a counteroffer file indicating whether the money deduction is successful, and then sends it to the bank terminal module 81.

The bank terminal module 81 receives the counteroffer file sent from the bank interface module 46, and verifies whether the money deduction is successful, a successful money deduction indicating the completion of repayment. In case of failed money deduction, the bank interface module 46 shall continuously initiate money deduction within one day. In case of failed money deduction on that day, the client's overdue time is recalculated.

In this embodiment, the Fintech mobile phone system APP 11 is installed in the mobile phone 1. The content distribution module 21 is arranged in the content distribution network server 2. The load balancing module 31 is arranged in the load balancing server 3. The mobile phone business module 41, the uniform interface module 42, the miraculous foresight module 43, the accounting module 44, the clearing service module 45, the bank interface module 46 and the post-loan module 47 are arranged in the master server 4. The short message service module 51 is arranged in the short message service server 5. The face scanning module 61 is arranged in the face scanning server 6. The third-party service module 71 is arranged in the third-party service server 7. The bank terminal module 81 is arranged in the bank server 8.

The miraculous foresight module 43 receives the bank card information and the face scanning information in the client application information sent from the uniform interface module 42, receives the loan contract, the cash withdrawal amount and the loan verification code sent from the Fintech mobile phone system APP 11, and receives the client's photo and the client's bank information sent from the third-party service module 71. Next, (a) the miraculous foresight module 43 checks whether the client's cash withdrawal amount is within the loan limit; (b) the miraculous foresight module 43 compares the face scanning information with the photo provided by the third-party service module 71 to check whether the operation is carried out by the client personally, and compares the bank card information with the client's bank information provided by the third-party service module 71 to check whether the bank card belongs to the client himself; (c) the miraculous foresight module 43 verifies whether the entered cash withdrawal password and the loan verification code are correct.

The accounting module 44 receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information sent from the uniform interface module 42, obtains the client's loan limit by calculation, and sends it back to the uniform interface module 42.

Compared with the prior art, by using the mobile phone APP loans system according to the above embodiment, a client can borrow money on a mobile phone via a mobile phone-based loan server, which is convenient in operation, so the client does not need to queue up in a banking office, thereby achieving a high speed of borrowing money.

Moreover, the client may repay money on the mobile phone, which is also convenient in operation, so the client does not need to queue up in the banking office, and there is no limitation to repayment deadline, such that the client may borrow and repay whenever.

Those skilled in the art should understand that the embodiments of the present invention may be provided as a method, a system or a computer program product. Therefore, the present invention may adopt forms of a full hardware embodiment, a full software embodiment, or an embodiment in combination of software and hardware aspects. Furthermore, the present invention may adopt the form of computer program products implemented on one or more computer storage media (including but not limited to a magnetic disk memory, a CD-ROM, an optical memory or the like) which includes a computer executable program code.

The present invention is described with reference to flowcharts and/or block diagrams of the method, equipment (system) and a computer program product according to the embodiments of the present invention. It should be understood that each flow and/or block in the flowcharts and/or block diagrams and a combination thereof may be implemented by means of computer program instructions. These computer program instructions may be provided for a general-purpose computer, a special-purpose computer, an embedded processor or processors of other programmable data processing equipment to generate a machine, so as to generate an apparatus used to implement designated functions in one or more flows of a flowchart and/or one or more blocks of a block diagram by means of instructions executed by a computer or a processor of other programmable data processing equipment.

These computer program instructions may also be stored in a computer-readable memory that can guide a computer or other programmable data processing equipment to work in a particular way, so that the instructions stored in the computer-readable memory generate a manufactured product including a command device that implements the designated functions in one or more flows of a flowchart and/or one or more blocks of a block diagram.

These computer program instructions may also be loaded on a computer or other programmable data processing equipment, to execute a series of operating steps on the computer or other programmable equipment to generate treatments implemented by the computer, so that instructions executed on the computer or other programmable equipment provide steps used to implement designated functions in one or more flows of a flowchart and/or one or more blocks of a block diagram.

Specific examples are employed above to set forth the present invention, which are only intended to assist in understanding the present invention but not to limit the present invention. Those of ordinary skill in the art may vary the above specific embodiments on the basis of the idea of the present invention.

1. A mobile phone APP loans system, wherein the mobile phone APP loans system is arranged on a network device constituted by a mobile phone, a server, a third-party service server, and a bank server linked by using a mobile communication network and Internet; the mobile phone APP loans system comprises a Fintech mobile phone system APP (11), a load balancing module (31), a mobile phone business module (41), a short message service module (51), a face scanning module (61), a uniform interface module (42), a miraculous foresight module (43), an accounting module (44), a clearing service module (45), a bank interface module (46), a third-party service module (71), and a bank terminal module (81);
the Fintech mobile phone system APP (11) is used to fill out a short-message verification code sent from the short message service module (51) to a client's mobile phone when a client registers on the mobile phone system APP, and fill out a loan verification code sent from the short message service module (51) to the client's mobile phone when the client withdraws cash; the client fills out loan application information via the Fintech mobile phone system APP (11), then encrypts it to obtain encrypted application information, and sends the encrypted application information to a content distribution module (21); the Fintech mobile phone system APP (11) receives a loan contract and a loan limit sent from the uniform interface module (42), in a cash withdrawal operation, the client fills out the loan contract and the loan verification code via the Fintech mobile phone system APP (11), sets a cash withdrawal password, and generates a cash withdrawal amount, an operable cash withdrawal amount in the cash withdrawal operation is within the loan limit, and then the loan contract, the loan verification code, the cash withdrawal amount and the cash withdrawal password are sent to the miraculous foresight module (43); the Fintech mobile phone system APP (11) receives the successfully verified loan contract sent from the miraculous foresight module (43), such that the client validates the loan contract, and then sends the validated loan contract to the miraculous foresight module (43);
the content distribution module (21) receives the encrypted application information sent from the Fintech mobile phone system APP (11), carries out data transmission and processing via the Internet to obtain client application information, and sends it to the load balancing module (31);
the load balancing module (31) distributes, the client application information sent from the content distribution module (21), to the mobile phone business module (41) based on an IP load balancing determination and content request distribution method;
after receiving the client application information sent from the load balancing module (31), the mobile phone business module (41) generates a short-message verification code, and sends it to the short message service module (51); the mobile phone business module (41) carries out data de-packetization on the client application information sent from the load balancing module (31) to obtain the de-packetized client application information: a user name, often-living-in city, limit of a single credit card, position, race, number of children, marital status, working hours recently, start working time, company name, nature of unit, position held, monthly income, mobile phone number, education level, mailbox, real estate information, current residential address, identity card information, bank card information, face information, signature information, and information on license terms consented by the user;
the mobile phone business module (41) sends the face information to the face scanning module (61); the mobile phone business module (41) sends the de-packetized client application information to the uniform interface module (42); the mobile phone business module (41) receives a photo comparison score sent from the face scanning module (61), validates and then saves the photo comparison score; the mobile phone business module (41) receives loan result information sent from the bank terminal module (81), generates a loan message, and sends the loan message to the short message service module (51);
the short message service module (51) receives the short-message verification code sent from the mobile phone business module (41), then generates a short message notice in line with mobile communication network transmission, and sends the short message notice to the client's mobile phone by way of a short message, and meanwhile the Fintech mobile phone system APP (11) displays that a time limit of entering the short-message verification code is one hour; when a client carries out the cash withdrawal operation via the Fintech mobile phone system APP (11), the client clicks on a short-message sending button on a screen, such that the short message service module (51) sends the loan verification code to the client's mobile phone; the short message service module (51) receives the loan message sent from the mobile phone business module (41), then generates a short message notice in line with mobile communication network transmission, and sends the short message notice, by way of a short message, to the mobile phone number filled out when the client registers;
the face scanning module (61) receives the face information sent from the mobile phone business module (41), compares the face information with the client's photo sent from the third-party service module (71), calculates based on the client's facial feature similarity between the two photos to obtain a photo comparison score, and then sends the photo comparison score to the mobile phone business module (41);
the uniform interface module (42) receives the de-packetized client application information sent from the mobile phone business module (41), and sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information to the accounting module (44); the bank card information and the face scanning information are sent to the miraculous foresight module (43); the uniform interface module (42) receives the client's loan limit sent from the accounting module (44); the uniform interface module (42) sends the loan contract downloaded from a master server (4) and the loan limit sent back from the accounting module (44) to the Fintech mobile phone system APP (11); the uniform interface module (42) sends the loan contract, the bank card information and the loan limit to the clearing service module (45); the uniform interface module (42) sends the user name, the identity card information, the signature information and the information on license terms consented by the user to the third-party service module (71); the uniform interface module (42) receives a credit score of the client sent from the third-party service module (71); the uniform interface module (42) sends the credit score to the miraculous foresight module (43);
the miraculous foresight module (43) receives the bank card information and the face scanning information sent from the uniform interface module (42), receives the loan contract, the cash withdrawal amount, the loan verification code and the cash withdrawal password sent from the Fintech mobile phone system APP (11) and saves the cash withdrawal password, receives the client's photo and the client's bank information sent from the third-party service module (71), and then sends again the successfully verified loan contract to the Fintech mobile phone system APP (11) after all the information is verified to be correct; the miraculous foresight module (43) receives the validated loan contract sent back from the Fintech mobile phone system APP (11), makes a loan, obtains a loan notice to the client, and sends the loan notice to the clearing service module (45); the miraculous foresight module (43) receives and saves the credit score sent from the uniform interface module (42);
the accounting module (44) receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information sent from the uniform interface module (42), calculates the client's loan limit, and sends the loan limit back to the uniform interface module (42);
the clearing service module (45) receives the loan contract, the bank card information and the loan limit sent from the uniform interface module (42) and the loan notice to the client sent from the miraculous foresight module (43), verifies whether the cash withdrawal amount is within the loan limit, and carries out loan notice processing once verified to be eligible, and the clearing service module (45) generates a loan message and sends the loan message to the bank interface module (46);
the bank interface module (46) receives the loan message sent from the clearing service module (45), processes the loan message to obtain the client's loan information, and sends it to the bank terminal module (81), the client's loan information being the client's cash withdrawal amount and the client's bank card information;
the bank terminal module (81) receives the client's loan information sent from the bank interface module (46), transfers the cash withdrawal amount in the client's loan information into the client's bank card, and sends obtained loan result information to the mobile phone business module (41), contents of the loan result information including loan succeeded or loan failed; and
the third-party service module (71) sends the client's photo to the face scanning module (61); the third-party service module (71) sends the client's photo and the client's bank information to the miraculous foresight module (43); the third-party service module (71) receives the user name, the identity card information, the signature information and the information on license terms consented by the user sent from the uniform interface module (42); and the third-party service module (71) obtains the client's credit rating score based on synthesis, and sends it to the uniform interface module (42).

2. The mobile phone APP loans system according to claim 1, wherein the mobile phone APP loans system further comprises a post-loan module (47), the uniform interface module (42) sends the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information in the application information to the post-loan module (47);
the post-loan module (47) receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information sent from the uniform interface module (42), makes an offer to obtain an offer amount, and sends the offer amount to the clearing service module (45), the offer amount being the client's need-to-pay amount;
the clearing service module (45) receives the offer amount sent from the post-loan module (47), generates an offer file, and sends it to the bank interface module (46);
the bank interface module (46) receives the offer file sent from the clearing service module (45), carries out a money deduction, obtains a counteroffer file indicating whether the money deduction is successful, and then sends it to the bank terminal module (81); and
the bank terminal module (81) receives the counteroffer file sent from the bank interface module (46), and verifies whether the money deduction is successful, a successful money deduction indicating a completion of repayment.

3. The mobile phone APP loans system according to claim 2, wherein the accounting module (44) receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address, the identity card information, the bank card information, the face information and the signature information sent from the uniform interface module (42), obtains a repayment date for the client by calculation, obtains the client's information of overdue payment by calculation based on the repayment date, and sends it to the miraculous foresight module (43);
the miraculous foresight module (43) receives the client's information of overdue payment sent from the accounting module (44), the client's information of overdue payment comprising overdue amount and overdue days, and sends it to the post-loan service module (47); and
the post-loan module (47) receives the user name, the often-living-in city, the limit of a single credit card, the position, the race, the number of children, the marital status, the working hours recently, the start working time, the company name, the nature of unit, the position held, the monthly income, the mobile phone number, the education level, the mailbox, the real estate information, the current residential address and the bank card information sent from the uniform interface module (42), receives the overdue amount and the overdue days sent from the miraculous foresight module (43), makes an offer to obtain an offer amount, and sends the offer amount to the clearing service module (45), the offer amount being the client's need-to-pay amount.

4. The mobile phone APP loans system according to claim 3, wherein there is provided with at least one bank terminal module (81).

5. The mobile phone APP loans system according to claim 4, wherein the third-party service module (71) is provided with a network shield module, a law summarizing module, a positioning module, an individual credit rating FICO module, and a K780 module working collaboratively; the network shield module is used to learn about client's past loan information; the law summarizing module is used to learn whether the client is involved in a financial case under progress in a court; the positioning module is used to learn about the client's sphere of activity; the individual credit rating FICO module is used to provide a credit score by integrating the results learned by the network shield module and the law summarizing module; and the K780 module is used to collect a mobile phone number, an identification IP address, an identity card number and a short URL provided by the client, then provide an inquiry service, and provide a short URL shortening service and a two-dimensional code generating service.

6. The mobile phone APP loans system according to claim 5, wherein the mobile phone is networked with a server, the server is networked with a third-party service server and a bank server, and the third-party service server and the bank server are respectively linked with at least one computer terminal.

7. The mobile phone APP loans system according to claim 6, wherein the server comprises a content distribution network server (2), a load balancing server (3), a master server (4), a short message service server (5), and a face scanning service server (6); a mobile phone (1) is connected to the master server (4) via the content distribution network server (2) and the load balancing server (3); and the master server (4) is connected to the short message service server (5), the face scanning service server (6), a third-party service server (7), and a bank server (8).

8. The mobile phone APP loans system according to claim 7, wherein there is provided with N mobile phones (1), the N being the number of users registered on the system; there is provided with M third-party service servers (7), the M being the number of servers connected to the system and providing credit, criminal records and credit inquiry information for the system; and there is provided with L bank servers (8), the L being the number of bank servers connected to the system and providing a loan.

9. The mobile phone APP loans system according to claim 8, wherein the Fintech mobile phone system APP (11) is installed in the mobile phone (1); the content distribution module (21) is arranged in the content distribution network server (2); the load balancing module (31) is arranged in the load balancing server (3); the mobile phone business module (41), the uniform interface module (42), the miraculous foresight module (43), the accounting module (44), the clearing service module (45), the bank interface module (46) and the post-loan module (47) are arranged in the master server (4); the short message service module (51) is arranged in the short message service server (5); the face scanning module (61) is arranged in the face scanning server (6); the third-party service module (71) is arranged in the third-party service server (7); and the bank terminal module (81) is arranged in the bank server (8).

10. The mobile phone APP loans system according to claim 9, wherein the miraculous foresight module (43) verifies following items: (a) checking whether the client's cash withdrawal amount is within the loan limit; (b) comparing the face scanning information with the client's photo provided by the third-party service module (71) to check whether the operation is carried out by the client personally, and comparing the bank card information with the client's bank information provided by the third-party service module (71) to check whether the bank card belongs to the client; and (c) verifying whether the entered cash withdrawal password and the loan verification code are correct.
